(19) United States
(12) Patent Application Publication
(10) Pub. No.: US 2008/0127573 A1
(43) Pub. Date: Jun. 5, 2008

(54) Slurry Composition for Final Polishing of Silicon Wafers and Method for Final Polishing of Silicon Wafers Using the Same

(75) Inventors: Hyun Soo Roh, Gunpo-si (KR); In Kyung Lee, Euiwang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: Cheil Industries Inc.

(21) Appl. No.: 11/616,915

(22) Filed: Dec. 28, 2006

(30) Foreign Application Priority Data
Dec. 5, 2006 (KR) 10-2006-0121887

(51) Int. Cl. C09K 3/14

(52) U.S. Cl. 51/298; 51/293; 51/308; 51/307

(57) ABSTRACT

Disclosed is a slurry composition for final polishing of silicon wafers to achieve mirror surfaces of the wafers. The slurry composition can include deionized water, abrasive particles, a pH-adjusting agent, a water-soluble thickener, an acetylene surfactant, and a heterocyclic amine. The particle diameter of the abrasive particles and the contents of the components can be selected so that the slurry composition can markedly reduce the number of LLS defects having a size larger than about 50 nm formed on the surface of wafers, and greatly reduce the haze and microroughness of wafer surfaces.

### FIELD OF THE INVENTION

The present invention relates to a slurry composition useful in final polishing of silicon wafers. More specifically, the present invention relates to a slurry composition for final polishing of silicon wafers that can reduce the microroughness or haze (which is a result of diffuse reflection of light by fine particle clusters) of polished wafer surfaces, as well as reduce the number of localized light scattering (LLS) defects having a size larger than about 50 nm formed on the surface of silicon wafers.

### BACKGROUND OF THE INVENTION

Chemical mechanical polishing (CMP), which is a final process for the production of silicon wafers, is performed to remove physical surface defects, such as microscratches, and to reduce the surface microroughness of silicon wafers, thus making the surface of the wafers soft. Wafers having undergone the CMP process can have mirror surfaces with few defects. In recent years, regulations to restrict the size of localized light scatter (LLS) defects detected due to microscratches and other defects formed on the surface of wafers have been increasingly stringent.

LLS defects having a size greater than 80 nm or 65 nm have been restricted. Regulations regarding defects having a size on the order of 50 nm or 30 nm are currently enforced. To comply with such strengthened regulations, there is a need for a slurry composition that is more effective for the removal of defects.

Silicon wafers are used as substrates for semiconductor manufacture. Silicon wafers are produced through a series of processes, such as single crystal growth, slicing, lapping, etching, polishing and cleaning. Polishing is a process for removing surface defects and subsurface damage, including scratches, splits, grain distortion, surface microroughness, surface topographical defects, etc., formed in the previous processes to produce defect-free wafers with mirror surfaces.

Processes for chemical mechanical polishing (CMP) of wafers involve some steps, i.e., a primary polishing step for removing deep surface scratches, which requires a high polishing rate, and a secondary polishing (mirror polishing) step for removing microscratches remaining after the primary polishing step and lowering the surface microroughness of wafers to the order of a few angstroms (Å) to achieve mirror surfaces of the wafers. That is, the final polishing step must be carried out to lower the surface microroughness of wafers to the order of a few angstroms (Å), reduce the haze, and decrease the amounts of residual fine particles and metal ions to the lowest possible levels (a few ppm).

These polishing steps necessitate the use of a soft or hard urethane polishing pad and a slurry composition other than a polisher and deionized water.

The polishing pad is responsible for mechanical polishing, and the slurry composition assists the mechanical polishing of the polishing pad and plays a role in chemical polishing. A considerable improvement in the performance of polishing pads and slurry compositions is required to produce high-quality large-diameter wafers.

Particularly, in view of the processing characteristics of large-diameter (300 mm) wafers, there is an increasing demand for the development of slurry compositions capable of achieving substantially defect-free surfaces.

Slurry compositions are used to chemically and physically promote the final polishing of CMP processes. General slurry compositions typically include an abrasive, a pH-adjusting agent and deionized water. For better polishing quality, slurry compositions may further include an organic or inorganic additive.

Monodisperse silica is mainly used as an abrasive, and an alkali base, such as potassium hydroxide or sodium hydroxide, or a non-metallic inorganic or organic base is generally used as a pH-adjusting agent. In addition to these components, additional functional additives may be used to achieve enhanced polishing effects. For example, an amine as a nonionic surfactant or a polishing accelerator can be additionally used to increase the polishing rate, improve the degree of cleaning of polished surface and enhance the dispersibility of abrasive particles. It is common to select slurry compositions depending on the processing characteristics of CMP processes.

U.S. Pat. No. 3,715,842 issued to Trednnick, et al. discloses a method for inhibiting aggregation and precipitation of silica to reduce the formation of scratches. According to this method, a slurry composition for final polishing of silicon wafers is prepared by dispersing settled silica particles having a size of 100 nm or less in water, adding ammonia to the dispersion to adjust the pH to 7 or higher, and adding a water-soluble cellulose selected from methylcellulose (MC), methylethylcellulose (MEC), ethylcellulose (EC), hydroxyethylcellulose (HEC) and hydroxypropylcellulose (HPC) in an amount of 0.05 to 2.5% by weight, based on the total weight of the slurry composition.

U.S. Pat. Nos. 4,169,337, 4,462,188 and 4,588,421 issued to Payne, et al. disclose slurry compositions for increasing the polishing rate. The slurry compositions are prepared by blending particles having a size of 4 to 100 nm with 2 to 4% by weight of an amine (e.g., aminoethylethanolamine or ethylenediamine) or 2 to 4% by weight of a quaternary ammonium salt (e.g., tetramethylammonium chloride or tetramethylammonia hydroxide (TMAH)).

U.S. Pat. No. 5,352,277 issued to Sasaki, et al. is directed to a slurry which can include colloidal silica including 20 to 50% by weight of silica having a size of 5 to 500 nm. The slurry can also include 20 ppm to 1000 ppm of a water-soluble polymer and 20 ppm to 1000 ppm of a water-soluble salt consisting of a cation selected from Na, K and NH₄ and an anion selected from Cl, F, NO₃ and ClO₄. The slurry is used to realize a soft surface whose microroughness is below 5 nm.

U.S. patent Publication No. 2001-0003672 filed by Inoue, et al. is directed to a secondary or finish polishing composition. The composition can include silica having an average particle size of 20 to 300 nm as an abrasive. Various embodiments can also include 0.001 to 0.3% by weight of TMAH as a base. This patent publication mentions that the addition of a hydroxyethylcellulose (HEC) having a molecular weight of 1.3×10⁶ led to an improvement in the hydrophilicity of wafer surfaces.

U.S. Pat. No. 6,354,913 issued to Miyashita, et al. is directed to a slurry composition for polishing the surface of a single-crystal silicon or polycrystalline silicon film. The slurry composition can include a water-soluble cellulose, such as hydroxyethylcellulose (HEC). The slurry composition can also include a pH-adjusting agent, including an amine such as triethanolamine, optionally in combination with an additional alkali agent which does not contain an alkali metal, e.g., ammonia and an amine having a relatively high vapor pressure. Importantly, the water-soluble cellulose, which is a major pollution source, is purified by ion exchange treatment to reduce the content of metal impurities.

However, these polishing slurry compositions lie within the general ranges, and particularly do not suggest improved performance in terms of light point defects (LPDs), haze and microroughness other than increased polishing rate.

### SUMMARY OF THE INVENTION

The present invention can provide an optimum slurry composition that uses abrasive particles having an optimum particle diameter to reduce the microroughness or haze (which is a result of diffuse reflection of light by fine particle clusters) of polished wafer surfaces and to reduce the number of LLS defects having a size larger than about 50 nm, which is the next standard specification issued in the semiconductor manufacturing industry, thereby improving the yield of processes for polishing silicon wafers.

According to the present invention, there is provided a slurry composition for final polishing of silicon wafers, the slurry composition including deionized water, abrasive particles, a pH-adjusting agent, a water-soluble thickener, an acetylene surfactant, and a heterocyclic amine.

In an embodiment of the present invention, the acetylene surfactant can be selected from an acetylene alcohol and an acetylene glycol represented by Formulae 1 and 2, respectively:

R₁R₂(OH)CC≡CH (1)

wherein R₁ and R₂ are each independently (OCH₂CH₂)ₙOCH₂CH₃ (in which n is from 0 to 10); and

R₁R₂(OH)CC≡CC(OH)R₁R₂ (2)

wherein R₁ and R₂ are each independently (OCH₂CH₂)ₙOCH₂CH₃ (in which n is from 0 to 10).

In a further embodiment of the present invention, the acetylene surfactant can be an acetylene glycol of Formula 2:

R₁R₂(OH)CC≡CC(OH)R₁R₂ (2)

wherein R₁ and R₂ are each independently (OCH₂CH₂)ₙOCH₂CH₃ (in which n is from 0 to 10).

In another embodiment of the present invention, the acetylene surfactant can be used in an amount of about 0.00001 to about 0.008% by weight, based on the total weight of the slurry composition that is diluted before use in the polishing of silicon wafers.

In another embodiment of the present invention, the acetylene surfactant can be used in an amount of about 0.00003 to about 0.003% by weight, based on the total weight of the slurry composition that is diluted before use in the polishing of silicon wafers.

In another embodiment of the present invention, the heterocyclic amine can be selected from the group consisting of piperidine, 1-ethylpiperidine, 1-(2-aminoethyl)piperidine, piperazine, 1-ethylpiperazine, 1-aminoethylpiperazine, 1-hydroxyethylpiperazine, 2-pyrrolidinone, and mixtures thereof.

In another embodiment of the present invention, the heterocyclic amine can be used in an amount of about 0.0001 to about 0.5% by weight, based on the total weight of the slurry composition that is diluted before use in the polishing of silicon wafers.

In another embodiment of the present invention, the heterocyclic amine can be used in an amount of about 0.001 to about 0.3% by weight, based on the total weight of the slurry composition that is diluted before use in the polishing of silicon wafers.

In another embodiment of the present invention, the abrasive particles can be colloidal silica particles.

In another embodiment of the present invention, the abrasive particles can have an average primary particle diameter of about 10 to about 70 nm.

In another embodiment of the present invention, the abrasive particles can have an average primary particle diameter of about 20 to about 30 nm.

In another embodiment of the present invention, the abrasive particles can be used in an amount of about 0.01 to about 10% by weight, based on the total weight of the slurry composition that is diluted before use in the polishing of silicon wafers.

In another embodiment of the present invention, the abrasive particles can be used in an amount of about 0.05 to about 7% by weight, based on the total weight of the slurry composition that is diluted before use in the polishing of silicon wafers.

In another embodiment of the present invention, the slurry composition can have a pH of about 9.5 to about 11.

In another embodiment of the present invention, the pH-adjusting agent can be ammonia.

In another embodiment of the present invention, the water-soluble thickener can be a polymer having a hydrophilic group.

In another embodiment of the present invention, the water-soluble thickener can be selected from the group consisting of polyvinyl alcohol, polyvinylpolypyrrolidone, polyoxyethylene, hydroxyethylcellulose, hydroxypropylcellulose, and mixtures thereof.

In another embodiment of the present invention, the cellulose compounds can have a weight average molecular weight of about 300,000 to about 8,000,000.

In another embodiment of the present invention, the water-soluble thickener can be used in an amount of about 0.001 to about 0.5% by weight, based on the total weight of the slurry composition that is diluted before use in the polishing of silicon wafers.

In yet another embodiment of the present invention, the slurry composition can have a viscosity of about 0.1 to about 50 cP.

According to the present invention, there is provided a method for final polishing of silicon wafers using the slurry composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention is directed to a slurry composition for final polishing of silicon wafers. The slurry composition can include deionized water, abrasive particles, a pH-adjusting agent, a water-soluble thickener, an acetylene surfactant, and a heterocyclic amine.

Any abrasive particles may be used in the present invention if they can be produced by a fuming or sol-gel process. Examples of suitable abrasive particles include silica (SiO₂), including colloidal silica particles, alumina (Al₂O₃), ceria (CeO₂), zirconia (ZrO₂), and titania (TiO₂), and mixtures thereof. The abrasive particles can have an average primary particle diameter of about 10 to about 70 nm, for example about 20 to about 30 nm, in order to reduce mechanical polishing effects and achieve improved surface state. If the average primary particle diameter of the abrasive particles is less than about 10 nm, sufficient mechanical polishing effects typically are not attained, which can cause a problem in terms of polishing rate, and there is the possibility that the abrasive particles may aggregate and be deposited due to polishing remnants, such as siloxane compounds, during polishing. Meanwhile, if the average primary particle diameter of the abrasive particles exceeds about 70 nm, there is the risk that subsurface damage may occur, resulting in an increase in haze value.

The abrasive particles can be used in an amount of about 0.01 to about 10% by weight, for example about 0.05 to about 7% by weight, based on the total weight of the slurry composition that is diluted before use in the polishing of silicon wafers.

The pH-adjusting agent can be used to adjust the pH of the slurry composition. The pH-adjusting agent can serve to improve the storage stability of the abrasive particles and impart an oxidizing power to the surface of silicon wafers. When silica particles are used as the abrasive particles, the pH of the slurry composition can be adjusted to a range of about 9.5 to about 11. Various kinds of organic and inorganic bases can be used to adjust the pH of the slurry composition. The amount of an organic or inorganic base used to adjust the pH of the slurry composition to a desired pH range may be varied according to the characteristics of the base. Ammonia, a weak base, can be used as the organic/inorganic base.

The water-soluble thickener can be used to enhance the dispersion stability of the abrasive particles during polishing and to induce the wettability of wafer surfaces. As the water-soluble thickener, a polymer having a hydrophilic group can be used. Examples of suitable water-soluble thickeners include polyvinyl alcohol, polyvinylpolypyrrolidone, polyoxyethylene, hydroxyethylcellulose, hydroxypropylcellulose, and mixtures thereof. The cellulose compounds can have a weight average molecular weight of about 300,000 to about 8,000,000.

The water-soluble thickener can be used in an amount of about 0.001 to about 0.5% by weight, based on the total weight of the slurry composition that is diluted before use in the polishing of silicon wafers. This amount can allow adjustment of the viscosity of the slurry composition to a range of about 0.1 to about 50 cP. When the viscosity of the slurry composition exceeds about 50 cP, the polishing rate of the slurry composition can decrease and the foamability of the slurry composition can increase, which can result in poor workability.

The acetylene surfactant and the heterocyclic amine can be simultaneously used to reduce the number of defects having a size larger than about 50 nm formed on the surface of wafers.

The acetylene surfactant can be selected from an acetylene alcohol and an acetylene glycol represented by Formulae 1 and 2, respectively:

R₁R₂(OH)CC≡CH (1)

wherein R₁ and R₂ are each independently (OCH₂CH₂)ₙOCH₂CH₃ (in which n is from 0 to 10); and

R₁R₂(OH)CC≡CC(OH)R₁R₂ (2)

wherein R₁ and R₂ are each independently (OCH₂CH₂)ₙOCH₂CH₃ (in which n is from 0 to 10).

An acetylene surfactant of Formula 1 or 2 in which n is greater than 10 can have low solubility and may cause increased foamability of the slurry composition. It is anticipated that the acetylene surfactant will provide the following two effects. Firstly, the use of the acetylene surfactant can enhance the defoamability of the slurry composition, which has good foamability and poor defoamability to improve the workability of the slurry composition. Secondly, the acetylene surfactant can serve to substantially uniformly spread the slurry over lipophilic wafer surfaces due to its inherent hydrophilicity. That is, the acetylene surfactant can greatly improve the hydrophilicity of lipophilic wafer surfaces and urethane polishing pads, and as a result, the number of LLS defects having a size larger than about 50 nm can be reduced.

The acetylene surfactant can be used in an amount of about 0.00001 to about 0.008% by weight, for example about 0.0003 to about 0.003% by weight, based on the total weight of the slurry composition that is diluted before use in the polishing of silicon wafers. When the acetylene surfactant is used in an amount of less than about 0.00001% by weight, an improvement in the defoamability of the slurry composition is typically not expected. Meanwhile, when the acetylene surfactant is used in an amount of more than about 0.008% by weight, there is the possibility that the number of LLS defects will increase.

The heterocyclic amine can be used to control the polishing rate of the slurry composition. The heterocyclic amine can be selected from the group consisting of piperidine, 1-ethylpiperidine, 1-(2-aminoethyl)piperidine, piperazine, 1-ethylpiperazine, 1-aminoethylpiperazine, 1-hydroxyethylpiperazine, 2-pyrrolidinone, and mixtures thereof.

The heterocyclic amine can be used in an amount of about 0.0001 to about 0.5% by weight, for example about 0.001 to about 0.3% by weight, based on the total weight of the slurry composition that is diluted before use in the polishing of silicon wafers. If the heterocyclic amine is used in an amount greater than about 0.5% by weight and smaller than about 0.0001% by weight, the polishing rate of the slurry composition can be considerably increased, resulting in an increase in the number of defects, such as haze.

The slurry composition of the present invention can be homogeneously mixed by various techniques before use in the final polishing of silicon wafers. In addition, defect-free wafers with mirror surfaces can be produced using the slurry composition of the present invention.

Hereinafter, the present invention will be explained in more detail with reference to the following examples. However, these examples are not intended to limit the present invention.

### EXAMPLES

### Example 1

Colloidal silica particles having a primary particle diameter of 20 nm are diluted in deionized water up to 5% by weight of the silica particles, and then 0.5% by weight of ammonia is added thereto to adjust the pH value to 10.8. 0.5% by weight of hydroxypropylcellulose having a weight average molecular weight of 400,000 is used as a water-soluble thickener. As indicated in Table 1, to the mixture are added 0.002% by weight of the acetylene glycol and 0.2% by weight of piperazine as a heterocyclic amine to prepare a slurry composition.

The slurry composition is diluted 40-fold with deionized water and used for polishing of silicon wafers. The diluted slurry is used to polish a p-type 200-mm flat wafer with a (100) orientation using a polisher (UNIPLA 211) to which a hard urethane polishing pad is attached. Thirty wafers are polished per slurry sample and the surfaces of the wafers are analyzed using a SURFSCAN SP-1 (KLA-TENCOR).

### Example 2

A slurry composition is prepared in the same manner as in Example 1, except that ethylpiperazine is used instead of piperazine. The polishing performance of the slurry composition is evaluated by the same procedure as described in Example 1.

### Example 3

A slurry composition is prepared in the same manner as in Example 1, except that aminoethylpiperazine is used instead of piperazine. The polishing performance of the slurry composition is evaluated by the same procedure as described in Example 1.

### Comparative Example 1

A slurry composition is prepared in the same manner as in Example 1, except that colloidal silica particles having a primary particle diameter of 50 nm are used instead of those having a primary particle diameter of 20 nm. The polishing performance of the slurry composition is evaluated by the same procedure as described in Example 1.

### Comparative Example 2

A slurry composition is prepared in the same manner as in Example 1, except that no acetylene surfactant is used and ethanolamine is used instead of piperazine. The polishing performance of the slurry composition is evaluated by the same procedure as described in Example 1.

### Comparative Example 3

A slurry composition is prepared in the same manner as in Example 1, except that ethanolamine is used instead of piperazine. The polishing performance of the slurry composition is evaluated by the same procedure as described in Example 1.

### Comparative Example 4

A slurry composition is prepared in the same manner as in Example 1, except that colloidal silica particles having a primary particle diameter of 50 nm are used instead of those having a primary particle diameter of 20 nm and ethanolamine is used instead of piperazine. The polishing performance of the slurry composition is evaluated by the same procedure as described in Example 1.

### Comparative Example 5

A slurry composition is prepared in the same manner as in Example 1, except that no acetylene surfactant is used. The polishing performance of the slurry composition is evaluated by the same procedure as described in Example 1.

The slurry compositions prepared in Examples 1 to 3 and Comparative Examples 1 to 5 and the polishing performance thereof are shown in Table 1.

TABLE 1

| | Components | | | Polishing performance | | |
|---|---|---|---|---|---|---|
| | Silica (Primary | | Amine polishing | >50 nm LLS | Haze | Rq*² |
| | particle diameter) | Acetylene surfactant | accelerator | (Number) | (ppm) | (Å) |
| Comparative | 50 nm | X | Ethanolamine | 70 | 0.138 | 2.25 |
| Example 1 | | | | | | |
| Comparative | 20 nm | X | Ethanolamine | 60 | 0.135 | 2.18 |
| Example 2 | | | | | | |
| Comparative | 20 nm | R₁R₂(OH)CC≡CCR₁R₂(OH)*¹ | Ethanolamine | 51 | 0.133 | 2.20 |
| Example 3 | | | | | | |
| Comparative | 50 nm | R₁R₂(OH)CC≡CCR₁R₂(OH)*¹ | Ethanolamine | 65 | 0.140 | 2.25 |
| Example 4 | | | | | | |
| Comparative | 20 nm | X | Piperazine | 55 | 0.136 | 2.19 |
| Example 5 | | | | | | |
| Example 1 | 20 nm | R₁R₂(OH)CC≡CCR₁R₂(OH)*¹ | Piperazine | 43 | 0.134 | 2.19 |
| Example 2 | 20 nm | R₁R₂(OH)CC≡CCR₁R₂(OH)*¹ | Ethylpiperazine | 38 | 0.134 | 2.20 |
| Example 3 | 20 nm | R₁R₂(OH)CC≡CCR₁R₂(OH)*¹ | Aminoethylpiperazine | 35 | 0.133 | 2.18 |

NOTE
*¹R₁ and R₂ = (OCH₂CH₂)₄OCH₂CH₃
*²Value obtained from 100-μm cut-off scanning by atomic force microscopy (AFM) This value indicates surface roughness

As can be seen from the results of Table 1, the use of the acetylene surfactant reduces the number of LLS defects and the optimum particle diameter of the silica particles results in a reduction in the number of LLS defects, haze and surface roughness. In addition, the combination of the acetylene surfactant and the heterocyclic amine leads to a marked reduction in the number of LLS defects.

As apparent from the above description, the slurry composition of the present invention can reduce the number of LLS defects having a size larger than about 50 nm formed on the surface of silicon wafers, and can reduce the haze and surface roughness of silicon wafers.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A slurry composition useful for final polishing of silicon wafers, the slurry composition comprising deionized water, abrasive particles, a pH-adjusting agent, a water-soluble thickener, an acetylene surfactant, and a heterocyclic amine.

2. The slurry composition according to claim 1, wherein the acetylene surfactant comprises an acetylene alcohol represented by Formula 1
R₁R₂(OH)CC≡CH (1)
wherein R₁ and R₂ are each independently (OCH₂CH₂)ₙOCH₂CH₃ in which n is from 0 to 10.

3. The slurry composition according to claim 1, wherein the acetylene surfactant comprises an acetylene glycol represented by Formula 2
R₁R₂(OH)CC≡CC(OH)R₁R₂ (2)
wherein R₁ and R₂ are each independently (OCH₂CH₂)ₙOCH₂CH₃ in which n is from 0 to 10.

4. The slurry composition according to claim 1, wherein the acetylene surfactant is used in an amount of about 0.00001 to about 0.008% by weight, based on the total weight of the slurry composition that is diluted before use in the polishing of silicon wafers.

5. The slurry composition according to claim 1, wherein the acetylene surfactant is used in an amount of about 0.00003 to about 0.003% by weight, based on the total weight of the slurry composition that is diluted before use in the polishing of silicon wafers.

6. The slurry composition according to claim 1, wherein the heterocyclic amine comprises a heterocyclic amine selected from piperidine, 1-ethylpiperidine, 1-(2-aminoethyl)piperidine, piperazine, 1-ethylpiperazine, 1-aminoethylpiperazine, 1-hydroxyethylpiperazine, 2-pyrrolidinone, and mixtures thereof.

7. The slurry composition according to claim 1, wherein the heterocyclic amine is used in an amount of about 0.0001 to about 0.5% by weight, based on the total weight of the slurry composition that is diluted before use in the polishing of silicon wafers.

8. The slurry composition according to claim 1, wherein the heterocyclic amine is used in an amount of about 0.001 to about 0.3% by weight, based on the total weight of the slurry composition that is diluted before use in the polishing of silicon wafers.

9. The slurry composition according to claim 1, wherein the abrasive particles comprise colloidal silica particles.

10. The slurry composition according to claim 1, wherein the abrasive particles have an average primary particle diameter of about 10 to about 70 nm.

11. The slurry composition according to claim 1, wherein the abrasive particles have an average primary particle diameter of about 20 to about 30 nm.

12. The slurry composition according to claim 1, wherein the abrasive particles are used in an amount of about 0.01 to about 10% by weight, based on the total weight of the slurry composition that is diluted before use in the polishing of silicon wafers.

13. The slurry composition according to claim 1, wherein the abrasive particles are used in an amount of about 0.05 to about 7% by weight, based on the total weight of the slurry composition that is diluted before use in the polishing of silicon wafers.

14. The slurry composition according to claim 1, wherein the slurry composition has a pH of about 9.5 to about 11.

15. The slurry composition according to claim 1, wherein the pH-adjusting agent is ammonia.

16. The slurry composition according to claim 1, wherein the water-soluble thickener comprises a polymer having a hydrophilic group.

17. The slurry composition according to claim 1, wherein the water-soluble thickener comprises a thickener selected from polyvinyl alcohol, polyvinylpolypyrrolidone, polyoxyethylene, hydroxyethylcellulose, hydroxypropylcellulose, and mixtures thereof.

18. The slurry composition according to claim 17, wherein the cellulose compounds have a weight average molecular weight of about 300,000 to about 8,000,000.

19. The slurry composition according to claim 1, wherein the water-soluble thickener is used in an amount of about 0.001 to about 0.5% by weight, based on the total weight of the slurry composition that is diluted before use in the polishing of silicon wafers.

20. The slurry composition according to claim 1, wherein the slurry composition has a viscosity of about 0.1 to about 50 cP.

21. A method for final polishing of silicon wafers using the slurry composition according to claim 1.
